(19) United States
(12) Patent Application Publication
(10) Pub. No.: US 2004/0109496 A1
(43) Pub. Date: Jun. 10, 2004

(54) Simultaneous bidirectional differential signalling interface

(76) Inventors: Alexander Roger Deas, Edinburgh (GB); Igor Anatolievich Abrosimov, St. Petersburg (RU); David Coyne, Edinburgh (GB)

Correspondence Address: Maria Nilova, 58, Moika Embankment, Office 501, St. Petersburg, 190000, RU

(21) Appl. No.: 10/387,443

(22) Filed: Mar. 14, 2003

(30) Foreign Application Priority Data
Dec. 9, 2002 (GB) 0228629.2

(51) Int. Cl. H04B 1/38

(52) U.S. Cl. 375/220; 375/257

(57) ABSTRACT

Bidirectional differential point to point simultaneous high speed signalling is provided between integrated circuits with highly effective echo canceling. Each integrated circuit comprises a transmitter for transmitting a first signal to another integrated circuit and a receiver for receiving a second signal from the other integrated circuit. The transmitter has an output buffer; a receiver has a receiver buffer and is co-located on the same integrated circuit; and a differential buffer is coupled between the input of the transmitter buffer and the output of the receiver buffer. To increase the quality of receiving the second signal, a third signal adjusted in phase and amplitude is coupled at the output of the receive buffer, so that the echoing of the first signal is canceled.

### BACKGROUND OF THE INVENTION

1. Technical Field

The present invention relates to high speed interfaces using differential signalling for communicating data between integrated circuits.

2. Background of the Invention

Point to point differential signalling is preferred for the communication of very high speed signals between integrated circuits. Such signalling provides significant benefits to the systems integrator and the integrated circuit designer, including reduced ground and power current injection, reduced EMI from the balanced differential lines, a large improvement in common mode noise immunity, and provides a basis to reduce number of power and ground pins compared with single ended signalling. The drawback of differential signalling compared to single ended signalling is that for every signal path, two wires are required. Neglecting the power and ground connections, a simple comparison of the pin and wire count between a differential signalling solution and a single ended signalling solution, such as JEDEC DDR 2, is unfavourable unless the differential solution operates at more than twice the data rate of the single ended solution.

A single ended bus uses tri-state drivers, so data can be transmitted in both directions across a single set of signal wires, with the data separated in time (time division multiplexing of the wire resource). This further improves the efficiency in terms of wire and pin count of the single ended solution. However, the bidirectional time division of the single ended bus requires a gap between the turnaround, such as between read and write operations, or read and command operations.

A differential point to point solution requires no turn around time, as each direction has dedicated wire resources.

Summarising this comparison, a byte wide single ended tristate bus sending 800 Mbps per wire, will require 8 signal pins plus typically 8 power and ground pins. A contemporary differential bus may send the same bandwidth of 6.4 Gbps (800 Mbps×8), across a differential pair in each direction. The total wire count is 4 signal wires, plus 4 power and ground pads. If the data rate is only 3.2 Gbps, the wire count for the same bandwidth as the single ended bus is identical, and below 3.2 Gbps, the wire count is higher.

Simultaneous bidirectional signalling across a differential wire pair is well known: telephone systems have been doing this for over 100 years. In a modern telephone system the return signal is removed using echo cancellation, and in the case of conference telephones, bidirectional echo cancellation. These systems use a hybrid circuit comprising transformers or an analogue network of resistors and operational amplifiers to extract the signal for the loudspeaker and inject the signal from the microphone into wire pair. With the introduction of digital signal processing, the echo cancellation in these telephony systems was implemented using an adaptive filter. In the telephony system, the echo cancellation tries to remove far end echo: significant near end echo is desirable so the user can hear himself—otherwise the user feels the line is dead. For modems, complete cancellation is desirable, and this is accomplished using a large signal processing budget. All these methods, from the simplest transformers up to the adaptive signal processors are impractical for digital systems communicating at very high speed.

A telephony hybrid circuit is shown in FIG. 2, comprising a microphone 1, 2 at each end of the differential channel 30, 31, and a loudspeaker 53 and 6. The microphone and loudspeaker are coupled into the channel by a transformer 7 and 8, and resistors such as 3 and 4. The loudspeaker responds only to currents injected into the channel, the microphone picking up a portion of this signal. The level of cancellation of this circuit is inadequate for the applications under consideration in this invention, and moreover at very high speeds, transformers operate across a narrow frequency band, which makes them unsuitable for sending data unless encoded, this coding reduces significantly the data payload of the channel. Improved passive versions of this hybrid circuit exist, but still provide around −18 dB of coupling between the channel directions which is insufficient rejection for the present application.

At very high speed, amplifiers have very low gain which makes them unsuitable for integration into devices for high speed channels, where significant gain is required to operate with the resistor networks such as is used in extracting the signal in each direction in the telephony system.

A very large number of high performance echo cancelling systems are known and many of these can provide very high levels of rejection between channels, but these need to operate at a multiple of the highest frequency in the channel: the sampling alone must be at least twice the maximum frequency in the channel that is being rejected. For high speed channels, such fast processors and their analogue to digital converters do not exist, nor can they ever exist because the signal processor needs to send data to and from memory a number of times for each sample and it is the connector of the processor to the memory that is a primary application of the present invention.

Echo cancelers have been used to minimize the effects of echo distortion in communication systems susceptible to echo systems including full-duplex, two-wire telecommunication systems. Echo cancelers in these and other systems operate by subtracting a replica of the echo of the original signal from the received signal. Examples of such apparatus is disclosed in U.S. Pat. No. 6,259,680 wherein the computational overhead associated with echo cancellation in a data communications system is reduced by utilizing symmetrical information rates at asymmetrical signal rates.

The design of a differential signalling system where both data for both directions is communicated on the same wires through time division multiplexing of the drivers is also well known, such as using tristate LVDS drivers and in RS485. Such an RS485 system provided by Maxim Integrated Products, Inc. (CA) is shown in FIG. 3, where two chips communicate across a differential channel 30, 31, each with their own electro-static discharge circuits (18, 19 and 28, 29). The transmit buffers 11, 12 (and 20, 21) may be implemented using parts such as a Maxim integrated circuit part number Maxim 3460 and Maxim 3461. Full duplex operation is provided by having multiple channels, with some channels operating in one direction and some in another, or half duplex operation is supported by using the device enable pins to put the drivers and or receivers into a high impedance state so the other side of the channel can drive the wire resource. The parts Maxim 3463 and Maxim 3464 are designed specifically for this mode of operation using time domain multiplexing of the wire resource, and is shown in Maxim data sheets as well as in very many other documents.

The data rate of such systems is much lower than for the applications contemplated here, such as at 20 MBps for the Maxim parts compared to 6 Gbps and above for the present invention, but the principles could be applied without undue difficulty by persons skilled in the art of high speed signalling at high speeds.

### OBJECT OF THE PRESENT INVENTION

It is a primary object of the present invention to reduce the wire count in a bidirectional differential signalling channel by a factor of two by enabling both directions to use the same pair of wires simultaneously, that is without time division multiplexing.

It is a further object of the present invention to reduce the number of bonding pads and the area required for bonding pads in a integrated circuit using differential signalling.

It is a further object of the present invention to maintain bidirectional signalling without sacrifice of transfer rate from time division multiplexing of the wire resource between different directions.

It is further object of the present invention to share the Electro-Static Discharge protection circuitry between transmitters and receivers.

It is further object of the present invention to reduce the power consumption by reducing the energy used in the terminators for signalling in both directions.

A particular form of the invention is suitable for memory to processor interfaces, high speed network interfaces and ASIC to ASIC interfaces.

### BRIEF SUMMARY OF THE INVENTION

In one aspect of the present invention an integrated circuit for point to point simultaneous bidirectional differential high speed signalling to another integrated circuit connected thereto, the integrated circuit comprising:

a transmitter for transmitting a first signal to another integrated circuit; the transmitter having an output buffer;

a receiver for receiving a second signal from the other integrated circuit, the receiver having a receiver buffer and co-located on the same integrated circuit; and

a differential buffer coupled between the input of the transmitter buffer and the output of the receiver buffer;

wherein the first signal at the output of the transmitter buffer is coupled into the input of the receiver buffer; and a third signal at the input of the transmitter buffer is coupled into the differential buffer and on to the output of the receiver buffer;

wherein the differential buffer adjusts the third signal in phase and amplitude to cancel the first signal at the output of the receiver buffer, whereby the quality of receiving the second signal is enhanced by canceling echoing of the first signal.

Preferably, the characteristics of the differential buffer, such as the gain and phase, are adjusted to achieve the maximum signal cancellation in the receiving buffer.

The differential buffer can be arranged as a plurality of stages, so that one or more buffer stage in a cancellation path can be disabled with the effect that the first signal is passed to the receiver for testing purposes.

The differential buffer can be implemented in N-type FET transistors to minimise the parasitic capacitance.

The gain of the differential buffer can be varied by means of a finite state machine using a pattern following power up or on request. The finite state machine employs a peak detector and means of reading a parameter related to the peak detector to set a value through digital to analogue converters which controls the currents sources in the differential stages in the chain of buffers providing the second signal between transmitter and receiver.

In another aspect of the invention, a method for point to point simultaneous bidirectional differential high speed signalling over the comminication media is provided, where the signalling is from one integrated circuit connected to another integrated circuit, each circuit comprising a transmitter having an output buffer and a receiver having a receiver buffer; the method comprising:

transmitting a first signal from the output buffer of the transmitter arranged on one integrated circuit, to another circuit, the first signal being coupled also into the input buffer of the receiver co-located with the transmitter on the same integrated circuit;

receiving a second signal from the other integrated circuit;

transmitting a third signal from the input of the transmitter buffer to a differential buffer where the third signal is adjusted in phase and amplitude; and

coupling the adjusted signal onto the output of the receiving buffer to cancel the first signal, whereby the quality of receiving the third signal is enhanced by canceling echoing of the first signal.

Still in one more aspect, an apparatus is provided for point to point simultaneous bidirectional differential high speed signalling between integrated circuits, the apparatus comprising an integrated circuit connected to another integrated circuit, each integrated circuit comprising:

a transmitter for transmitting a first signal to another integrated circuit; the transmitter having an output buffer;

a receiver for receiving a second signal from the other integrated circuit, the receiver having a receiver buffer and co-located on the same integrated circuit;

a differential buffer coupled between the input of the transmitter buffer and the output of the receiver buffer; and

a state machine for controlling the differential buffer in gain and phase;

wherein the first signal at the output of the transmitter buffer is coupled into the input of the receiver buffer; and

a third signal at the input of the transmitter buffer is passed through the differential buffer and is coupled onto the output of the receiver buffer;

wherein the differential buffer adjusts the third signal in phase and amplitude to cancel the first signal at the output of the receiver buffer, whereby the quality of receiving the second signal is enhanced by canceling echoing of the first signal.

### BRIEF DESCRIPTION OF THE SEVERAL VIEWS OF THE DRAWINGS

For a better understanding of the present invention and the advantages thereof and to show how the same may be carried into effect, reference will now be made, by way of example, without loss of generality to the accompanying drawings in which:

Fig.1 shows a simultaneous bidirectional signalling system according to the present invention.

FIG. 2 shows a prior art simultaneous bidirectional signalling system for telephony applications.

FIG. 3 shows a prior art bidirectional signalling system using time division multiplexing of the wire resource.

FIG. 4 shows an improved echo cancellation system in digital form suitable for high speed binary data transfer according to the present invention.

FIG. 5 shows a differential stage for the regulated amplifier in FIGS. 1 and 4.

FIG. 6 shows a diagram of the dual integrator amplitude and phase cancellation sensors.

FIGS. 7a, b and c shows timing diagrams relating to the operation of the amplitude cancellation sensor.

FIGS. 7d, e and f shows timing diagrams relating to the operation of the phase cancellation sensor.

FIG. 8a shows an amplitude cancellation sensor with integrator, sample and hold and buffer.

FIG. 8b shows a phase cancellation sensor with a full-wave rectifying integrator, sample and hold device and buffer.

FIG. 9a shows a transfer function of the amplitude cancellation sensor.

FIG. 9b shows a transfer function of the phase cancellation sensor.

FIG. 9c shows a transfer function of the phase cancellation sensor with incomplete amplitude cancellation.

FIGS. 10a, b, c and d show waveforms relating to points in the amplitude and phase cancellation sensor circuits.

FIGS. 11a and b shows the implementation of the integrating and sample and hold capacitors.

FIG. 12 shows a diagram of a common mode feedback loop to remove common mode offsets in the amplitude cancellation sensor.

FIGS. 13a, b, c, and d shows the flow diagram for the calibration of the channel using the amplitude and phase cancellation sensors.

### DETAILED DESCRIPTION OF THE INVENTION

The invention will now be described in detail without limitation to the generality of the present invention with the aid of example embodiments and accompanying drawings.

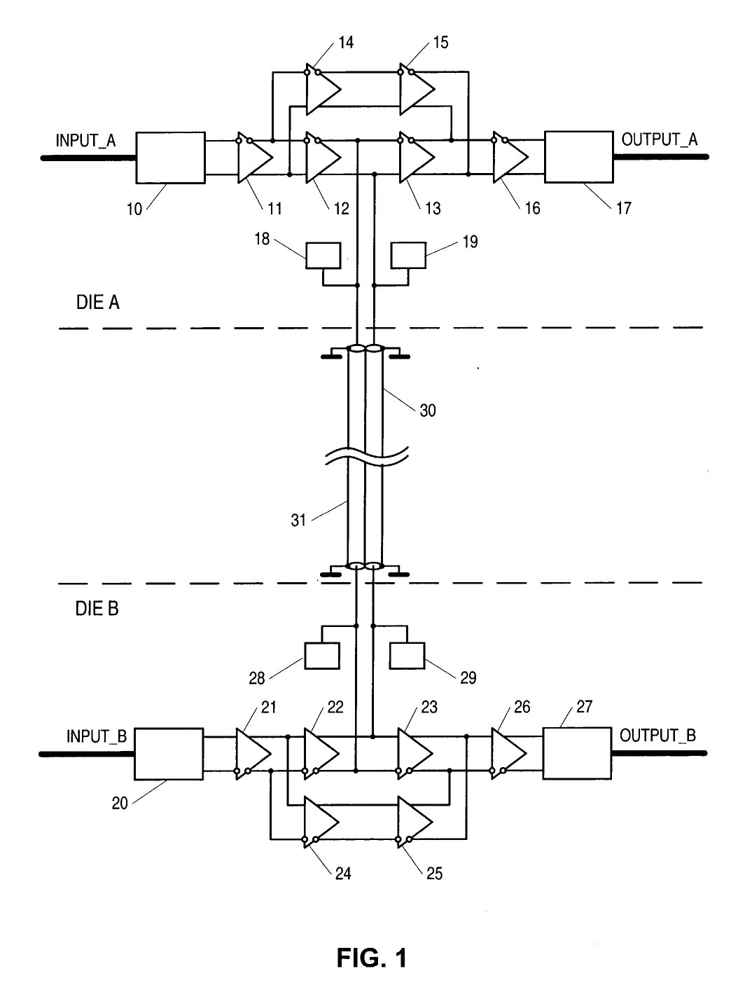

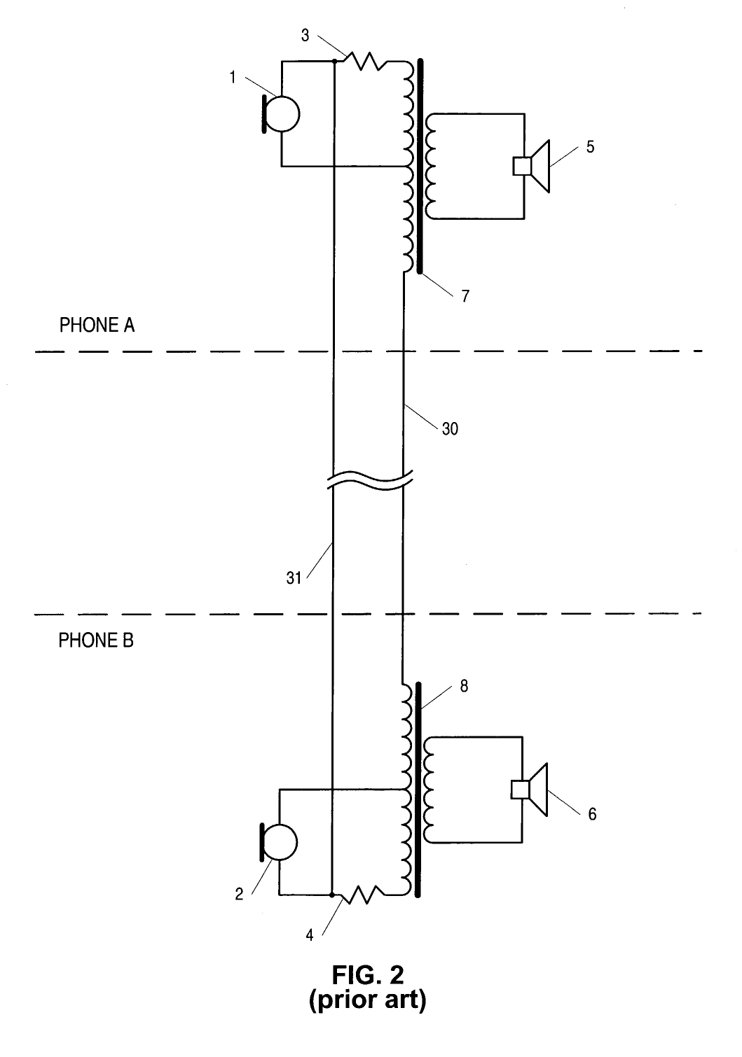

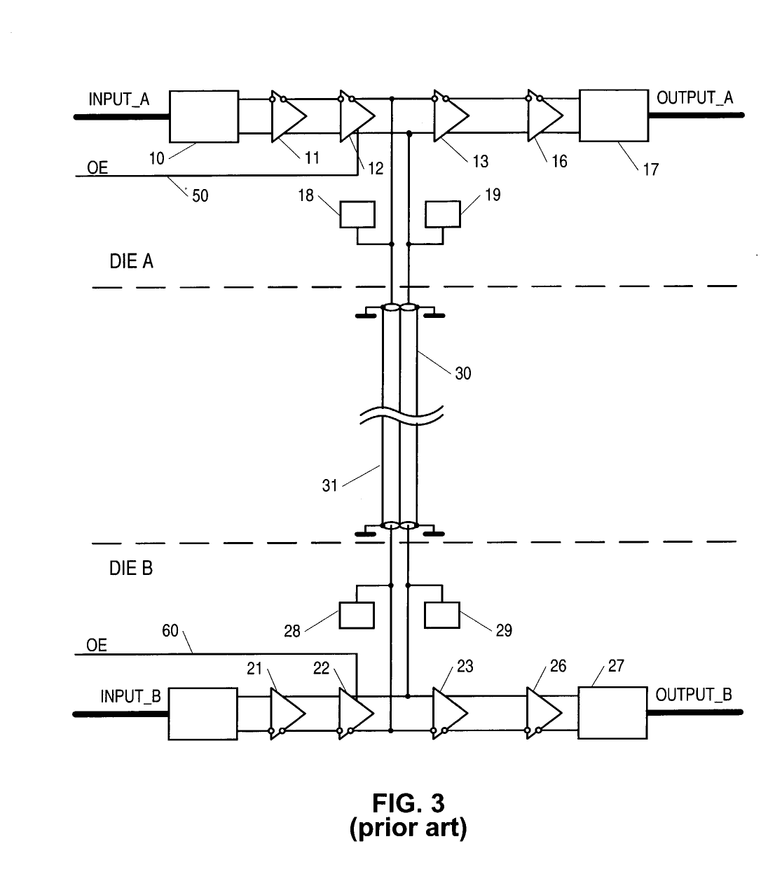

FIG. 1 shows a differential channel, with a pair of signal wires, 30 and 31, connecting two dies, Die A and Die B in a point to point connection. Each die has the same circuit, comprising for Die A, an ESD structure on each wire, 18 and 19, and input buffers 13 and 16 each of which would normally comprising a chain of buffers, which may include integral Miller capacitance compensation and integral signal emphasis or other conditioning. On the same die, an input bus A is serialised by serialiser 10 which may also include other circuits such as verniers, phase or pulse modulating circuits, and then drives a first high speed signal through differential driver stages, 11 and 12, each of which normally comprises a chain of buffers and preferably includes signal pre-emphasis and is preferably structured to compensate for Miller capacitance.

A first signal is transmitted from Die A to Die B and a second signal is transmitted from Die B to Die A. A third signal, which is a copy of the first signal in the drive chain, is taken and applied to the receive chain, via a buffer, 14 and 15, such that the polarity and/or phase of this third signal applied to the receive chain is the opposite to the polarity of the first transmit signal that is coupled into the receive chain, 13 and 16, by virtue of the receiver input 13 being connected to the driver output 12. Where this third cancelling signal exactly matches the amplitude and phase of the first coupled signal, while the polarity is opposite, then none of the output transmit signal appears on the output of the receiver buffer 16. The output of buffer 16 therefore represents only the signal received from Die B, without any component from the signal transmitted by Die A.

The nature of the coupling of the transmit signal into the receive channel is that the coupled signal appears as non-common mode noise in the receive channel, therefore must be cancelled, as the differential stages have a high rejection only of common mode noise. Typically the receive channel will be insensitive to non-common mode (differential) noise below 10 mV, and the transmit signal will have an amplitude of several hundred mV, such as 350 mV. Therefore the cancelling circuit must be typically of 5 bit or more accuracy.

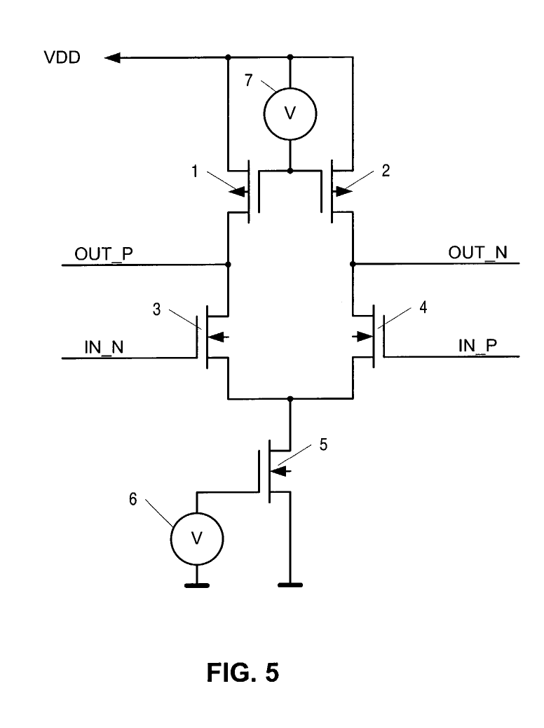

Each of the buffers of FIG. 1 (11, 12, 13, 14, 15 and 16), can be of the form shown in FIG. 5, where a differential input signal, IN_N and IN_P is amplified to give a differential output signal OUT_P and OUT_N respectively, by amplifying transistors 3, and 4, with their sources connected to a current source such as is formed by an N type transistor with a voltage source 6 driving its gate, and the load, preferably formed by transistors 1 and 2 with a voltage source 7 driving their gate. The gain through the stage can be varied by variation of the voltage sources driving the different gates, to adjust the gain and the phase shift of the signal being fed forward to nullify the coupling of the transmitter output to the receiver chain.

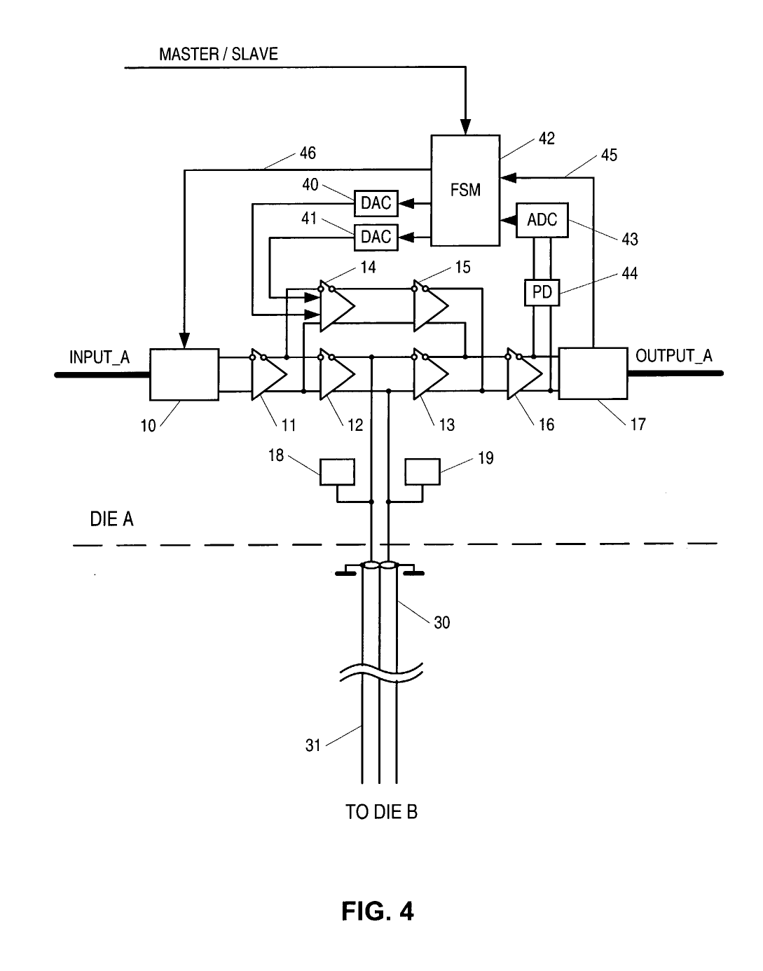

FIG. 4 shows a means by which the proportion of the cancelling signal can be determined and applied. This comprises the same circuit elements with the same labels as in FIG. 1, but with the addition of a peak detector 44, driving a circuit 43 which converts the amplitude of the output of the peak detector 44 to a digital form, this being applied to a state machine 42, which drives two digital to analogue converters, 40 and 41, to set the two voltage sources shown in FIG. 5. In some applications, the modulation of only one voltage source may be possible, depending on the detailed design of the differential stage, the transistor characteristic, the voltage headroom and the load device. In a viable but non-preferred implementation the load device may be simply a resistor implemented in polysilicon which is unable to be modulated, leaving only the current source providing a common sink current as the gain control means. In this case, the phase of the signal must be determined by careful circuit analysis and may be established statically. The preferred implementation controls both voltage sources (that is, controls all current sources).

The finite state machine (FSM) 42 in FIG. 4 operates as follows. Upon power up or shortly thereafter, the FSM sends a training pattern into the channel by introducing a signal 46 into the transmitter chain. The FSM then varies the amplitude of the signal into the DACs 40 and 41. The finite state machine determines the codes in the DACs which corresponds to the minimum peak to peak noise by using a peak detector 44 and ADC 43. At the end of adjustment process the determined codes are applied to the DACs. During this search to establish a null signal with optimum gain and phase, the second Die, Die B, is quiet, it acting as a slave.

After the master has been configured, the slave Die goes through a similar sequence. The configuration of which is the master and which is the slave can be set by control bits that are normally found in communication channels to control various aspects of the mode of operation. This control bit, shown as a Master/Slave signal, in FIG. 4 normally is provided by a register. Die B may time out to determine the duration of the procedure in Die A, or may listen to the channel to observe when the channel is quiet following activity following power up. In this listen mode, Die B transmitter is inactive. This time out can be implemented using counters incorporated into the FSM 42, which for omitted from the diagrams to maintain their clarity.

The output impedance of the buffers 12 and 22 in FIG. 1 should preferably match the line.

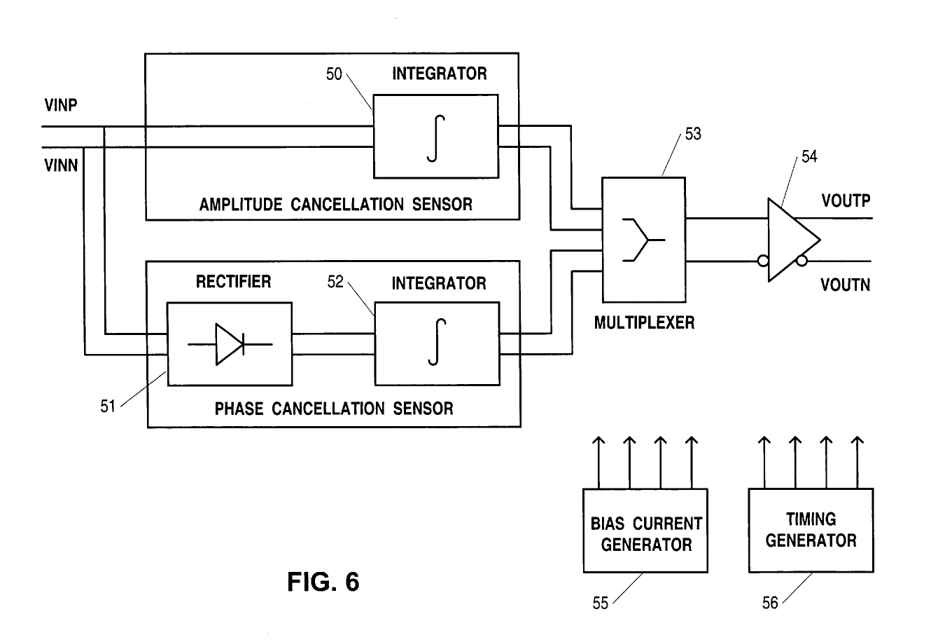

The finite state machine should preferably have a control from a register enabling it to switch off the signal path through the buffers 14 and 15 in FIG. 4, to enable a complete internal loop back of the transmit signal to the receive path, for the purposes of device testing. Another embodiment of a circuit as an alternative to the Peak Detector 44 is now described. The circuit depicted in FIG. 6 senses the amount of gain and phase cancellation. FIG. 6 shows the signal split into two paths. The upper path is passed through an integrator 50 producing an output which is directly related to the amount of amplitude cancellation. The lower path passes through a rectifier 51, the output of which is then integrated by integrator 52 producing an output which is proportional to the amount of phase cancellation. The outputs of the integrators 50 and 51 are passed through a multiplexer 53 to an output buffer 54, which drives the ADC 43. The multiplexer is controlled by a signal from the FSM 42 which selects the output from one of the integrators to be connected to the ADC 43. Bias and timing control blocks 55 and 56 are included which are under control of the FSM 42 enhancing the sensitivity and also allowing other calibration techniques. Gain and phase cancellation are performed separately in this embodiment although in another embodiment multiple ADC's may be used to measure the gain and phase cancellation at the same time.

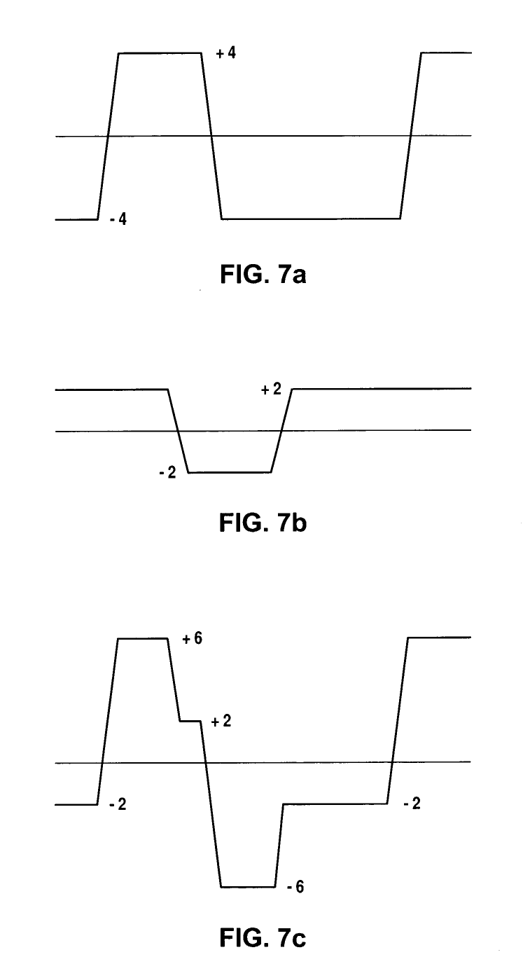

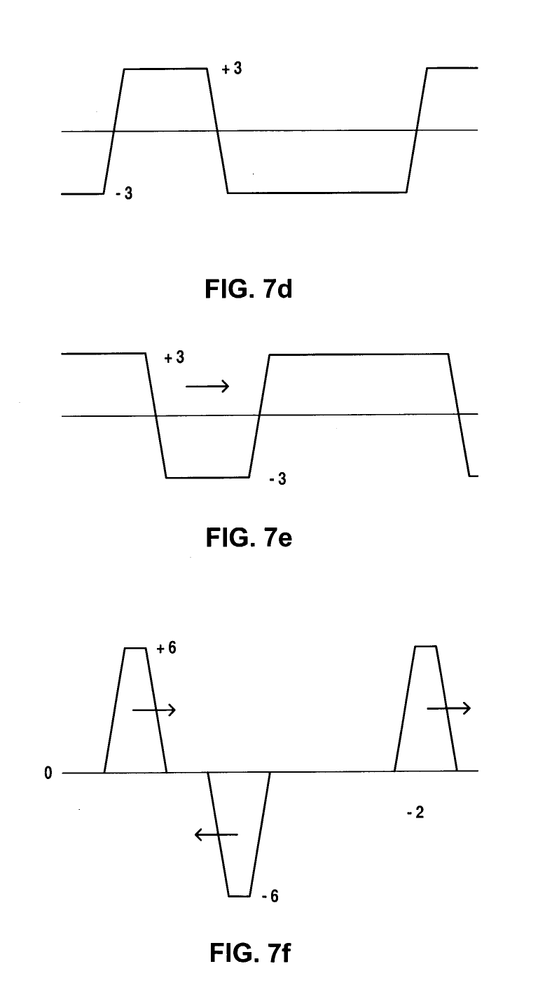

To explain the above dual integrator scheme, reference is first made to the timing diagrams in FIGS. 7a, 7b and 7c. FIGS. 7a, 7b and 7c show binary waveforms relating to the signals in the channel during calibration. These signals are the output of the transmit buffer, the output of the cancellation amplifier and the residual signal from summing of the two afore-mentioned signals respectively. The pattern applied to the channel has a mark to space ratio which is not unity. In this embodiment the mark to space ratio is 1:3. It should be noted that other patterns with different mark to space ratio's and number of levels have characteristics which would work with the circuits in this embodiment.

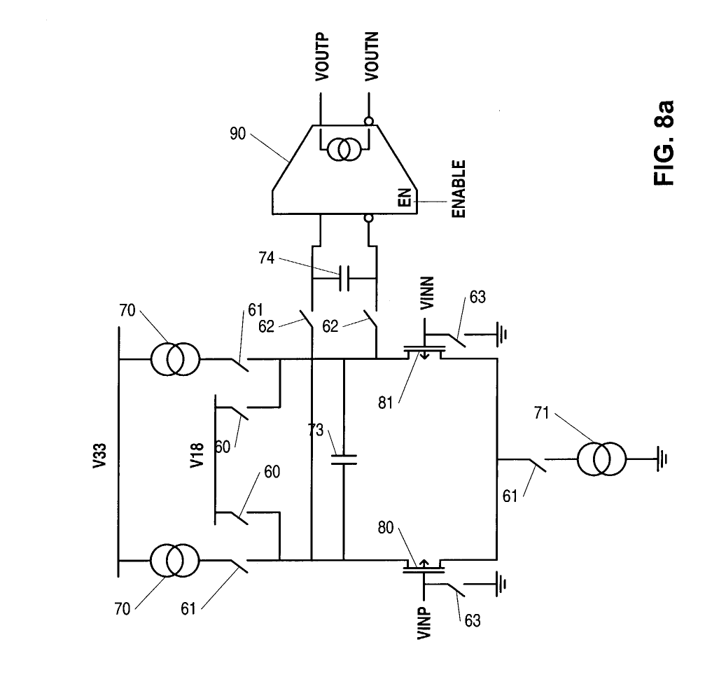

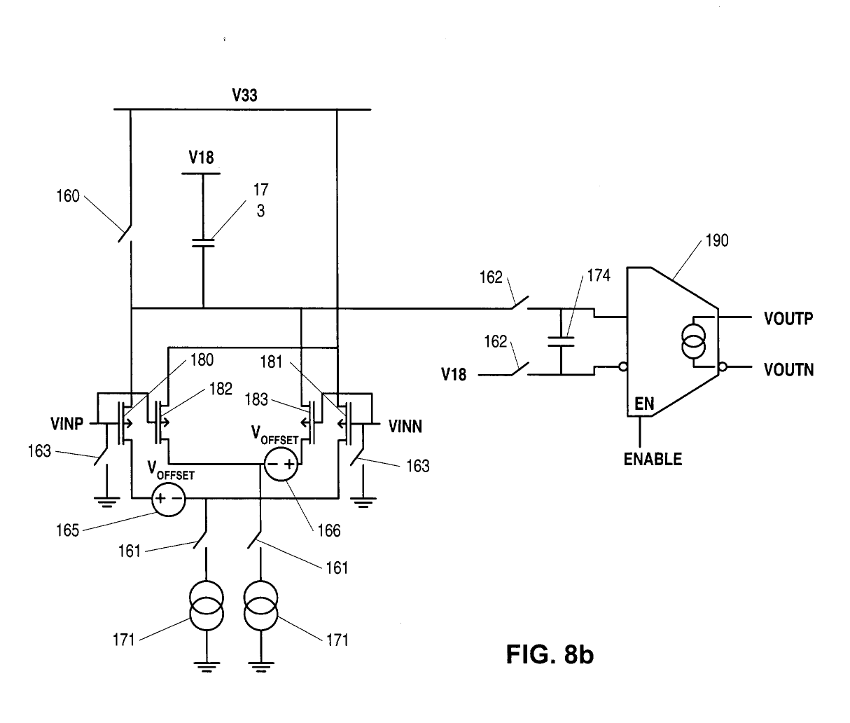

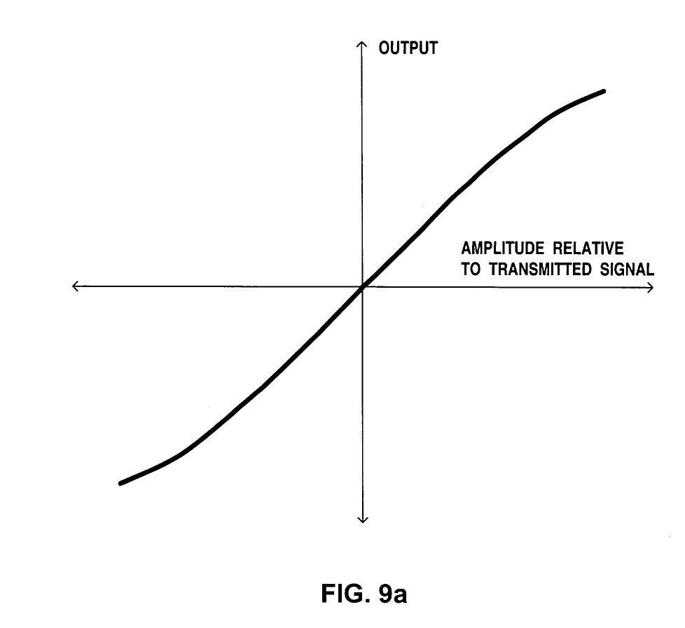

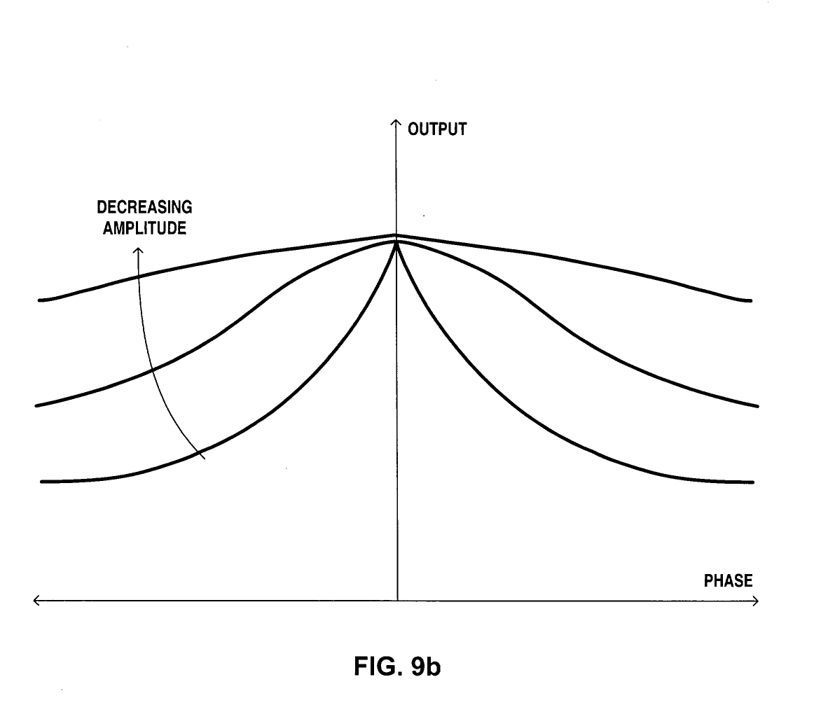

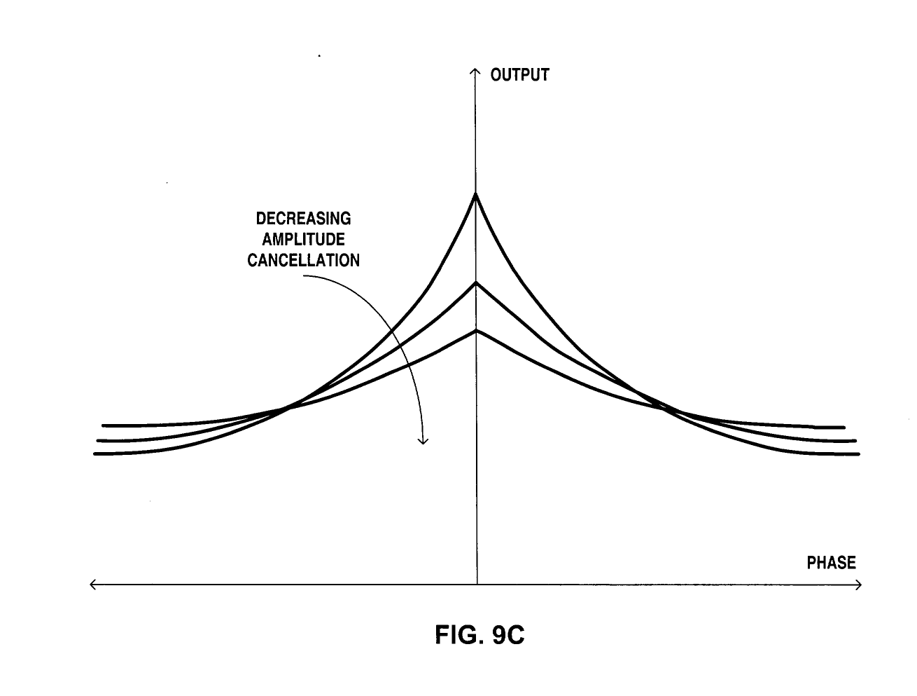

It can be observed that the waveform of the incompletely cancelled signal in FIG. 7c has certain characteristics which may be exploited with different types of sensors which may be used to provide information on the degree of amplitude or phase cancellation. An amplitude cancellation sensor may be formed by integrating the signal in FIG. 7c. A signal which does not have a mark to space ratio of unity contains a dc content and this characteristic is to be used in the amplitude cancellation sensor. An embodiment of such an integrator is shown in FIG. 8a and its transfer function, the output voltage versus the cancellation signal amplitude, is shown in FIG. 9a.

In a similar manner it can be seen that for a residual signal in the channel as depicted in FIGS. 7d and 7e, where the amplitude has been cancelled but the phase has not been cancelled, a half-wave or full-wave rectifier followed by an integrator can produce a phase cancellation sensor. FIGS. 7d and 7e show two different phase cancellation conditions. An embodiment of such a sensor is shown in FIG. 8b and the transfer function of the sensor is shown in FIG. 9b.

It can be clearly seen that although a binary signal with a mark to space ratio of 1:3 has been used in this embodiment, the techniques are clearly applicable to signals of multiple levels and/or different mark to space ratios and/or different patterns.

FIG. 8a is now described.

The amplitude cancellation sensor is formed by an integrator, a sample and hold device and output transconductance amplifier or buffer. Transistors 80 and 81 form a differential pair with current sources 70 and 71 providing the biasing for the differential pair. The residual signal from the channel is applied to the gates of transistors 80 and 81 which produces a differential output current at the drains of the same transistors. This current flows into the integrating capacitor 73 and produces a voltage across that same capacitor. The charge stored in the integrating capacitor 73 at the end of the integration period is shared with any charge in the sample and hold capacitor 74 during the transfer period, yielding an output voltage relative to the degree of amplitude cancellation.

Switches 60, 61, 62 and 63 control the different phases of the integrator operation. There are three phases in this design, a reset phase, an integration phase and a transfer phase. A cycle is formed by a reset phase followed by an integration phase which is followed in turn by a transfer phase. The whole cycle repeats continuously throughout the cancellation calibration period. The length of each of these phases is generally significantly longer than the period of the pattern in order to ensure that integration of an incomplete cycle of the residual waveform does not generate an inaccurate result. In this embodiment the switches are formed by NMOS or PMOS transistors or both NMOS and PMOS transistors.

In the reset phase switches 60 are closed and each end of the integrating capacitor 71 is connected to supply V18. Switches 61 are open, removing the bias currents from the differential pair, 80 and 81. Switches 62 are open, leaving the sample and hold capacitor, 74, in the hold mode. Switches 63 are closed connecting the gates of transistors 80 and 81 to ground turning off the differential pair.

In the integration phase switches 60, 62 and 63 are opened. The input voltage applied across the gates of transistors 80 and 81 produces a differential current which flows in capacitor 73 and a differential voltage across the capacitor 74.

In the transfer phase switches 60 are open, switches 61, 62 and 63 are closed. The transistors 80 and 81 are forced off by the removal of bias current and clamping of the gate voltages. Capacitors 73 and 74 are now connected in parallel and charge is shared between these two capacitors. The voltage across the capacitors is dependent on the value of each capacitance and the initial voltages across each capacitor. However, after multiple cycles, the voltage on both capacitors will become asymptotic to the voltage on integrating capacitor 73 at the end of the integration phase. In this embodiment the capacitors are of equal size and it requires that the integrator repeat the integration/transfer phase 6 times to achieve an accuracy of 1%. More cycles result in higher accuracy.

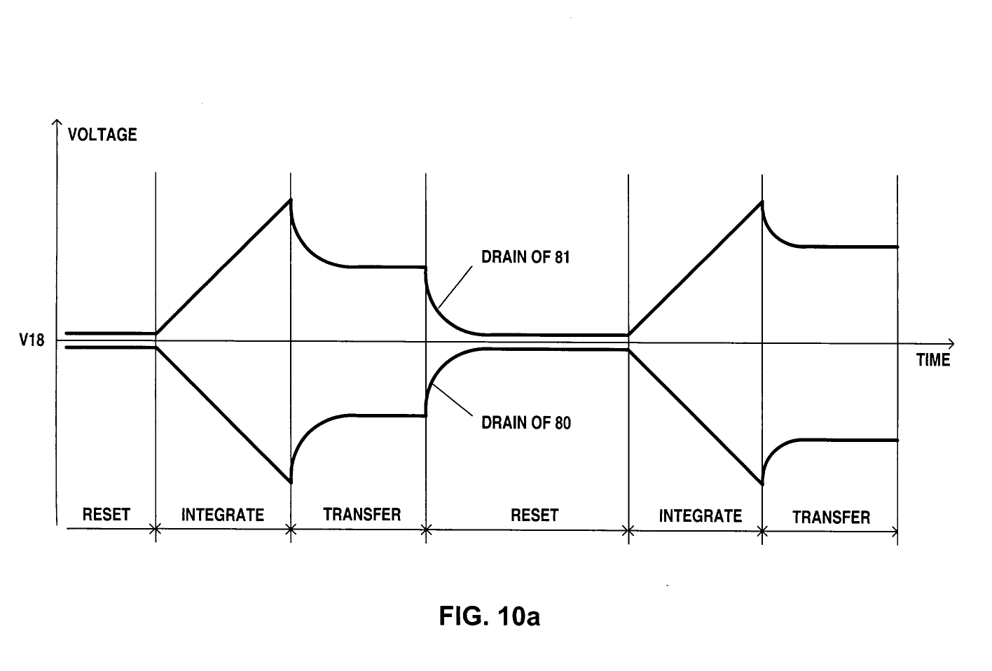

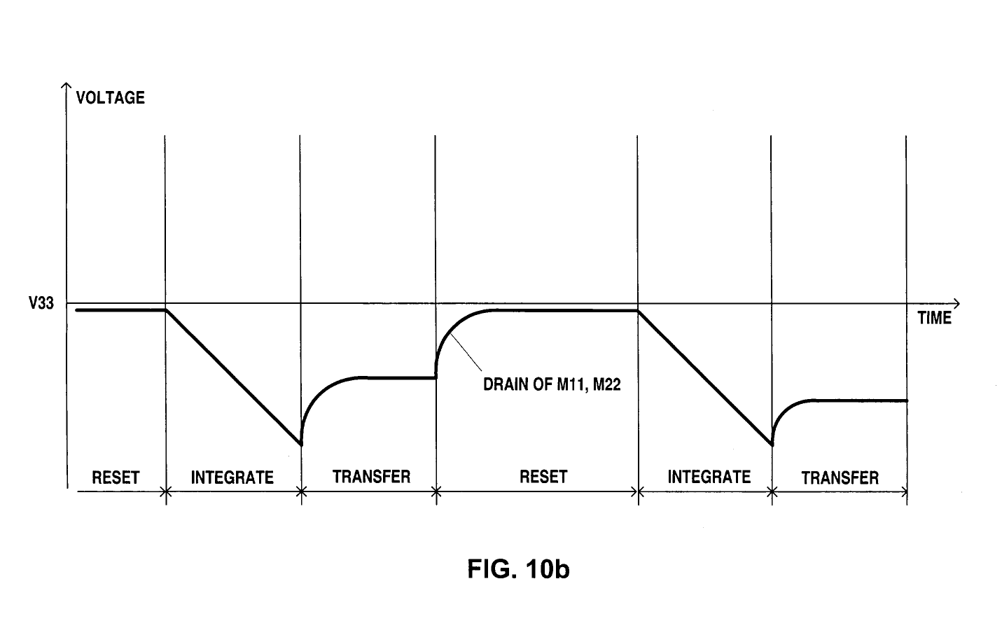

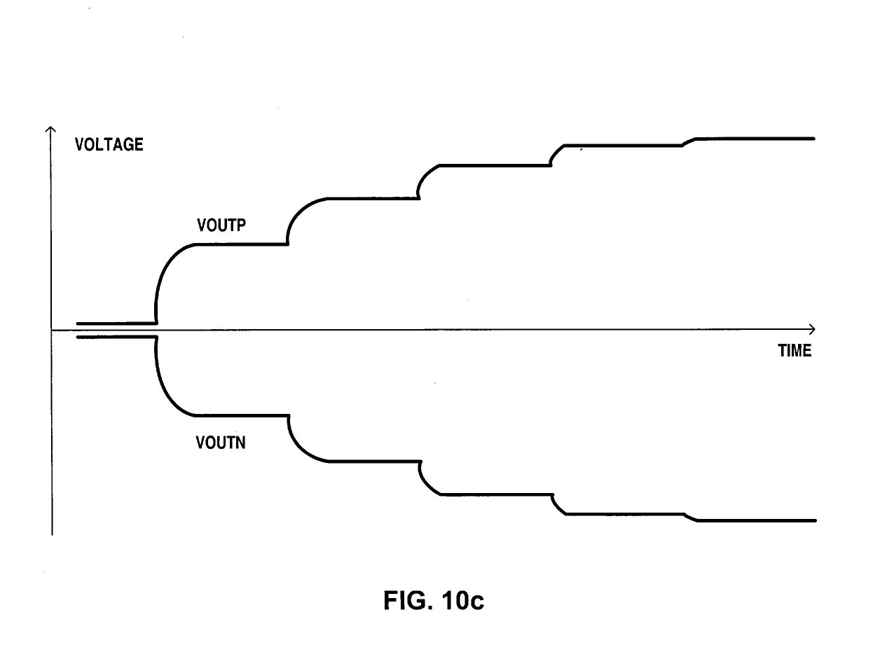

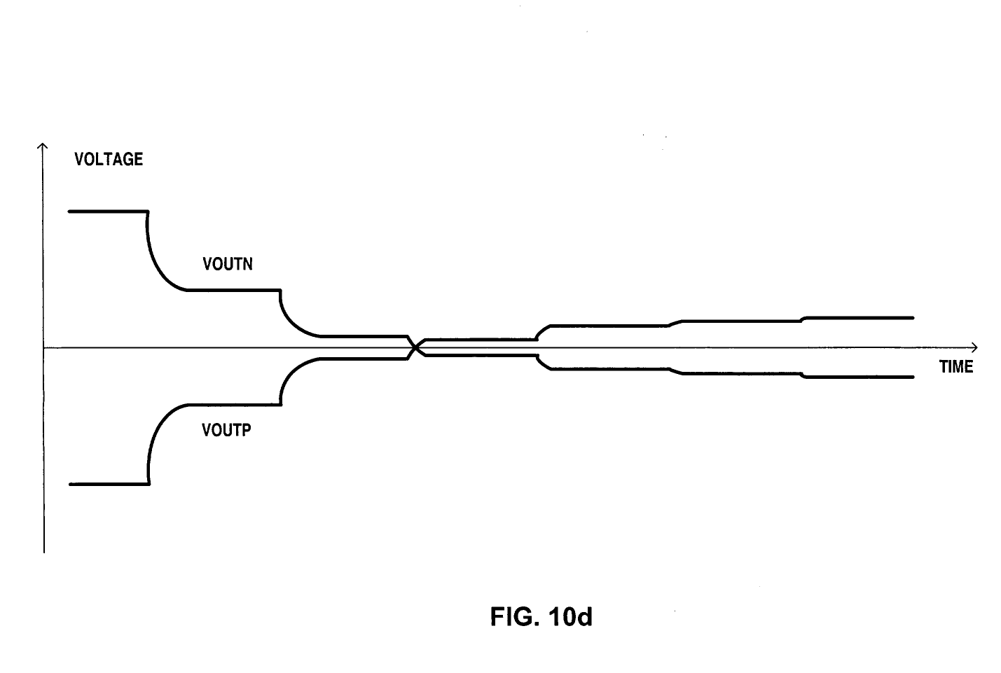

Typical waveforms in this circuit are shown in FIG. 10a. The waveforms show the voltage at the drain of transistors 80 and 81. The linear ramp region is the integration phase. These waveforms show the first integration cycle where there is no voltage on capacitor 74. During the transfer phase the charge stored in capacitor 73 is shared with capacitor 74 and the voltage drops by a factor of two. During the second transfer phase capacitor 74 has a charge equal to half that on capacitor 73 so that at the end of the second transfer phase the voltage across capacitors 73 and 74 is three-quarters of the final voltage. On each transfer phase the voltage at the end of the transfer phase is incremented by half of the difference between the voltage across capacitors 73 and 74 at the beginning of the transfer phase. The waveforms in FIG. 10c show the output of the complete amplitude cancellation sensor circuit from the first cycle. In this waveform it can be clearly seen that the differential output voltage starts at zero and increase at the transfer phase of each cycle becoming close to a static value after a small number of cycles.

In another embodiment it is possible to place a differential voltage buffer between the integrating capacitor 73 and the sample and hold comprising of switches 62 and capacitor 74 such that the charge sharing did not occur. This would allow the output voltage to be obtained after just one integration cycle.

The voltage across the sample and hold capacitor 74 is fed to a differential buffer 90 and routed through a multiplexer 53 and buffer 54 to the ADC 43.

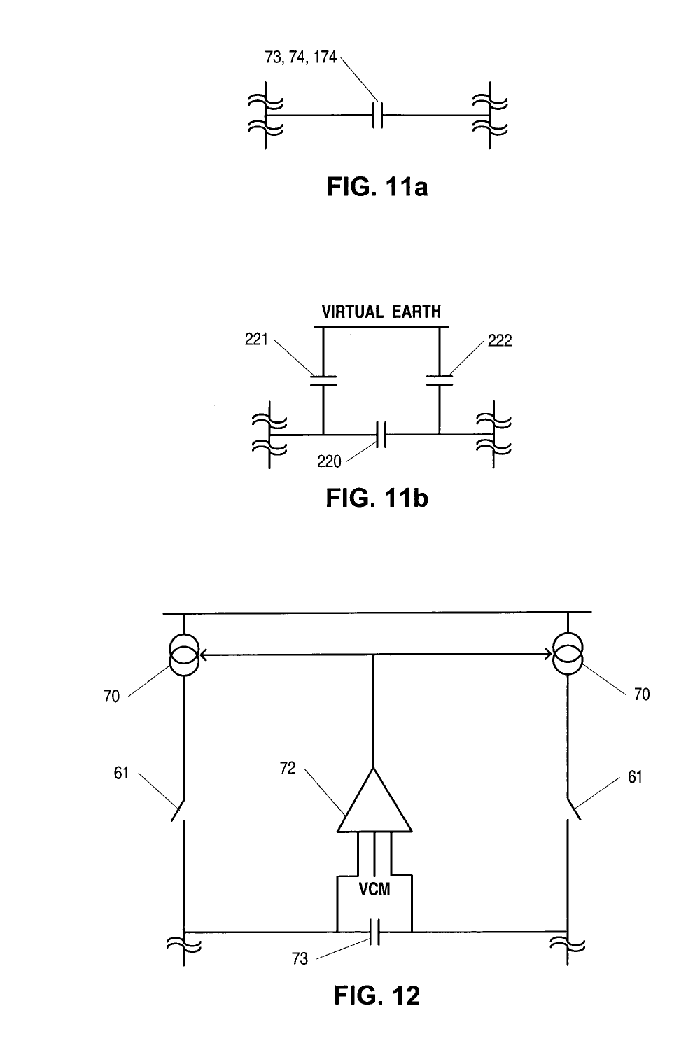

The capacitors 73 and 74 are implemented as shown in FIG. 11. A combination of differential and common mode capacitance is used in order to minimise voltage excursions due to mismatches in the circuit components and charge feedthrough effects.

Offsets within the amplitude cancellation sensor circuit are handled, firstly, by accurate matching of the current sources 70 and 71 plus traditional layout techniques and sizing of transistors 80 and 81. Secondly, a calibration routine is performed as the first step in the amplitude cancellation algorithm which is described later.

Mismatch errors between the sum of the currents 70 and the current 80 exhibit themselves as common mode offsets. Common mode offsets can be accommodated within the dynamic range of the circuit or, if the common mode offset is too large, by a common mode feedback circuit as depicted in FIG. 12. In FIG. 12 an amplifier 72 senses the common mode voltage across capacitor 73 and compares this against a reference voltage VCM. An error signal is then used to control current sources 70 to eliminate the common mode signal.

Mismatch errors in current sources 70 or, in transistors 80 and 81, exhibit themselves as a differential offset which would degrade the amplitude cancellation accuracy. In this embodiment an offset cancellation routine is performed as the first step in the overall amplitude cancellation algorithm. A second signal is injected into the channel which utilises a pattern with a 1:1 mark to space ratio. With a symmetric signal applied to the amplitude cancellation sensor circuit 50 it is possible to measure the offset at the output of the integrator through the ADC, 43. This voltage can then be subtracted from subsequent measurements from the amplitude cancellation sensor circuit when the pattern with a 1:3 mark to space ratio is injected into the channel. Offsets in the sample and hold and buffer are common to both sets of measurements and therefore also cancel. The calibration procedure is shown in the flow diagram in FIG. 14 as part of the algorithm for controlling the cancellation circuit operation.

It is also recognised that in another embodiment an offset measurement could be performed by shorting together the gates of transistors 80 and 81.

The amplitude cancellation sensor is relatively immune to phase differences between the transmitted signal and the cancellation signal. This is due to amplitude symmetry within the waveform of the high frequency content.

FIG. 9a shows the typical transfer function curve for integrator 50. The differential output voltage passes through zero when the amplitudes of the transmitted and cancellation signals are equal. The transfer function starts to saturate for large amplitudes of the cancellation circuit. However, the overall transfer function is still monotonic which allows its use in a control loop.

In this embodiment the sensitivity of the amplitude cancellation sensing circuit can be increased when close to the point of amplitude cancellation by increasing the bias currents 70 and 71 generated from the bias current generator 55.

FIG. 8b is now described:

The embodiment of the phase cancellation sensor formed by rectifier 51 and integrator 52 is a full-wave rectifying integrator followed by a sample and hold followed by a transconductor, amplifier or buffer.

The full-wave rectifying integrator is formed by two differential pairs of transistors, 180,181 and 182,183 configured with a deliberate voltage offset 165, 166 introduced into the sources of one transistor in each differential pair. The drains of transistors 181 and 182, which do not have the offset voltage in their source, are connected directly to one of the positive supply voltages. The drains of transistors 180 and 183, which do have the offset in the source, are connected together and to an integrating capacitor 173.

The phase cancellation sensor circuit formed by rectifier 51 and integrator 52 operates with three phases in a similar manner to the operation of the amplitude cancellation sensor 50.

In the reset phase switch 160 is used to reset the voltage across capacitor 173. One end of the capacitor 160 is connected to V33 while the other end is permanently connected to V18. Switches 161 are open removing the bias from transistors 180,181,182 and 183. Switches 163 are closed, shorting the gates of transistors 180, 181, 182 and 183 to ground. Switches 162 are open placing the sample and hold capacitor 174 in the hold mode.

In the integration phase, switch 160 is open allowing the integrating capacitor 174 to be charged when current flows in the drains of transistors 180 and 183. Switches 161 are closed allowing bias current to be applied to the transistors 180, 181, 182 and 183. Switches 162 are open maintaining the sample and hold capacitor 174 in the hold mode. Switches 163 are opened allowing the residual signal from the channel to operate on the gates of the differential pairs formed by transistors 180, 181 and 182, 183.

During the integration phase, the residual signal from the channel is applied across the gates of each differential pair formed by transistors 180, 181 and 182, 183. When the differential input signal VINP-VINN is larger than the offset, 165, current flows in transistor 180 which charges the capacitor 173, increasing the voltage across the capacitor. Similarly, when the differential input signal VINN-VINP is larger than the offset 166 current flows in the drain of transistor 183 and results in the voltage across capacitor 173 increasing. In this way the signal is clipped, full-wave rectified and integrated.

Current is generated by both differential pairs from positive or negative portions of the residual signal. The voltage across the capacitor is single-ended in this embodiment and a differential signal is generated in the differential buffer after the sample and hold capacitor by the use of a fixed voltage for the other half of the differential signal.

The integrating capacitor 173 is reset to V33 as current is always unipolar from the full-wave rectifier, resulting in the voltage on the capacitor always going more negative than V33. This increases the dynamic range of the circuit.

The capacitor 173 only has a common mode component as it operates single-ended. However, the sample and hold capacitor, 174 retains both common mode and differential components as shown in FIG. 12.

In the transfer phase switches 160 and 161 are open with switches 162 and 163 closed. The charge on the integrating capacitor 173 is shared between the integrating capacitor 173 and sample and hold capacitor 174. After a number of cycles the voltage on the sample and hold capacitor 174 increases asymptotically to the value of the voltage across the integrating capacitor just prior to the transfer period.

After the transfer phase the reset phase occurs and the cycle repeats continuously. It should be noted that the insertion of a buffer between the integrating capacitor 173 and the switches 162 for the sample and hold could result in an output which could be obtained without the multiple cycles of the present embodiment.

The phase cancellation sensor circuit formed by 51 and 52 has a degree of immunity to variations in signal amplitude. FIG. 9b shows the transfer function of the phase cancellation sensor circuit for different amplitudes of the residual signal in the channel. There is still a peak in the transfer function at the phase cancellation point although the sensitivity is degraded.

It is possible in this embodiment to increase the circuit sensitivity close to the optimum cancellation point by increasing the bias currents 171 by control of the main bias current generator 55.

The phase cancellation sensor has a certain degree of immunity in the presence of non-complete amplitude cancellation. FIG. 9c shows the transfer function of the phase cancellation sensor circuit for small differences in the amplitudes of the transmitted and cancellation signals. There is still a peak in the transfer function at the phase cancellation point but the magnitude of the peak has diminished. This can be accommodated within the dynamic range of the circuit.

Calibration of offsets could be performed by placing a short-circuit across the gates of 180, 181, 182 and 183. However, the circuit is not very sensitive to small offsets due in part to the large headroom achieved by resetting the integrating end of 173 to V33.

The offsets in the sources of the differential pairs, 165 and 166 may be introduced by deliberately mismatching the input transistors. However, in this embodiment an offset is generated with the introduction of a resistor in the source of one half of each differential pair and a current source feeding into the node at the junction of the source and resistor. This is depicted in FIG. 8d. The current source in this embodiment, 161, is made to vary with the sheet resistance of the resistors used in the sources, 167, in order that the offset remain fixed over process and temperature. In another embodiment it is possible to introduce an offset which varies as a function of process parameters.

FIG. 8c shows the multiplexing of the outputs of the amplitude cancellation and phase cancellation sensor buffers, 90 and 190. A control signal from the FSM, 42, is connected to the enable of buffer 90 and to an inverter 210. The output of inverter 210 is connected to the enable of buffer 190. As buffers 90 and 190 are transconductance stages the output current can be enabled or disabled by the logic state of the control signal from the FSM. A logic high on the control signal integrator_select will enable the output current from buffer 90 while a logic low will enable the output current from buffer 190. Transistors 200 and 201 form a cascade stage which maintains a low impedance on the multiplexed outputs enabling the whole circuit to be placed close to the edge of the integrated circuit.

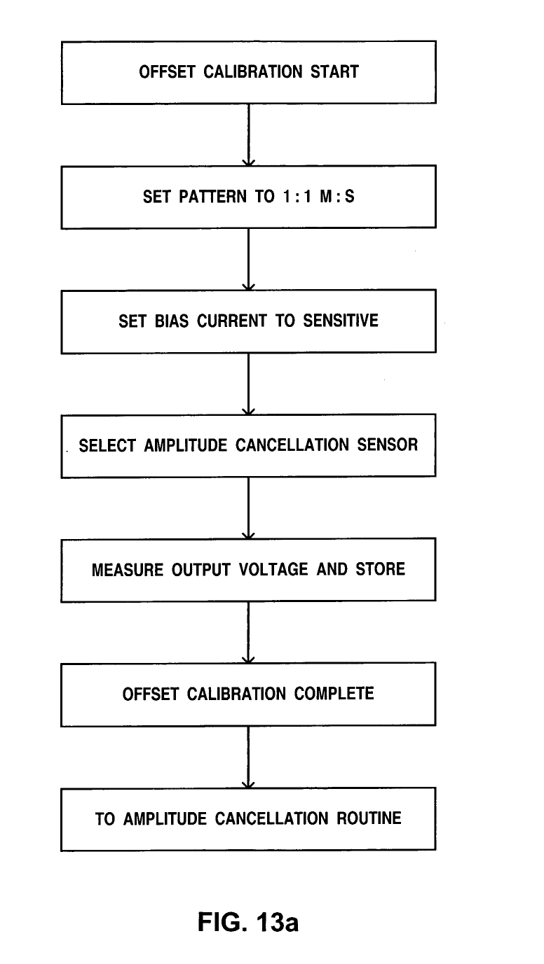

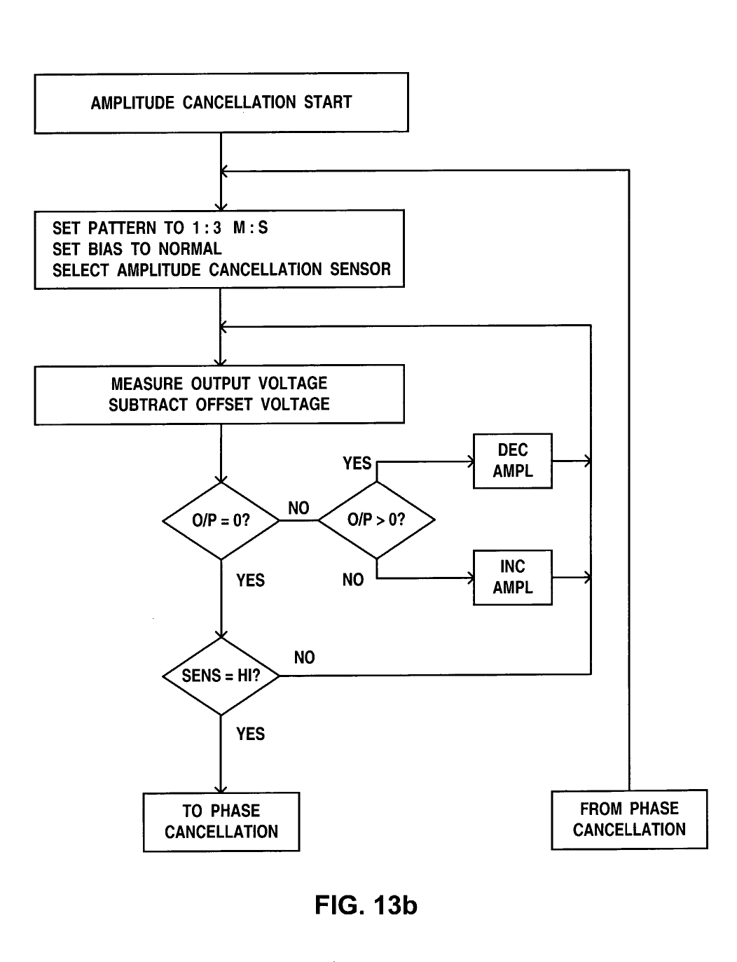

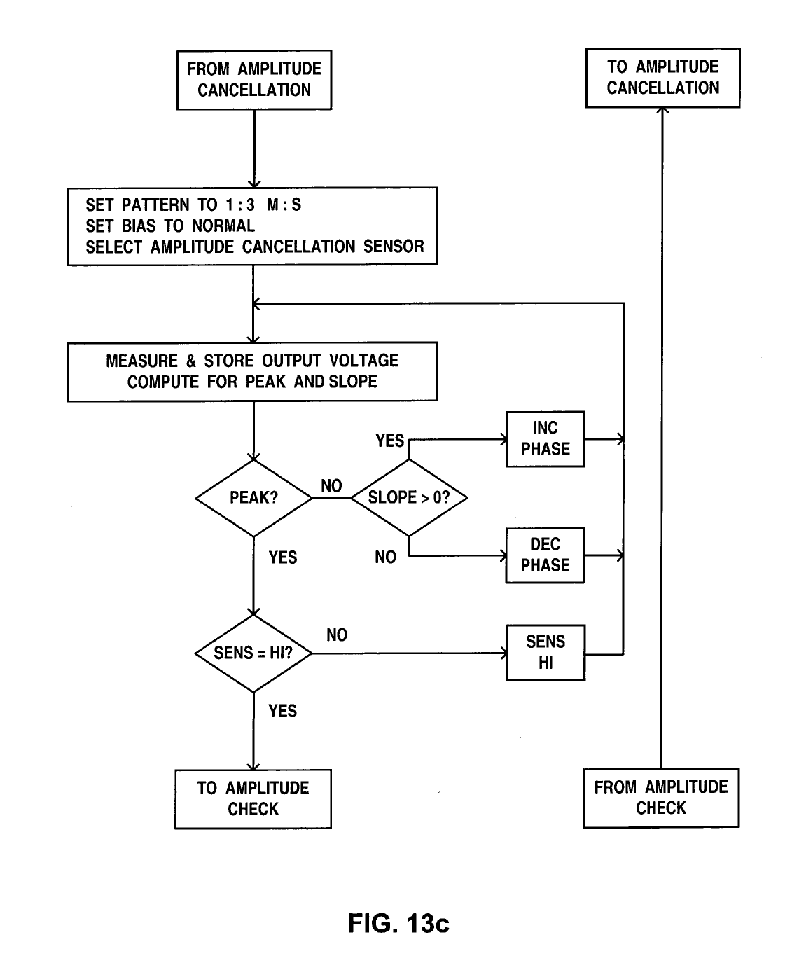

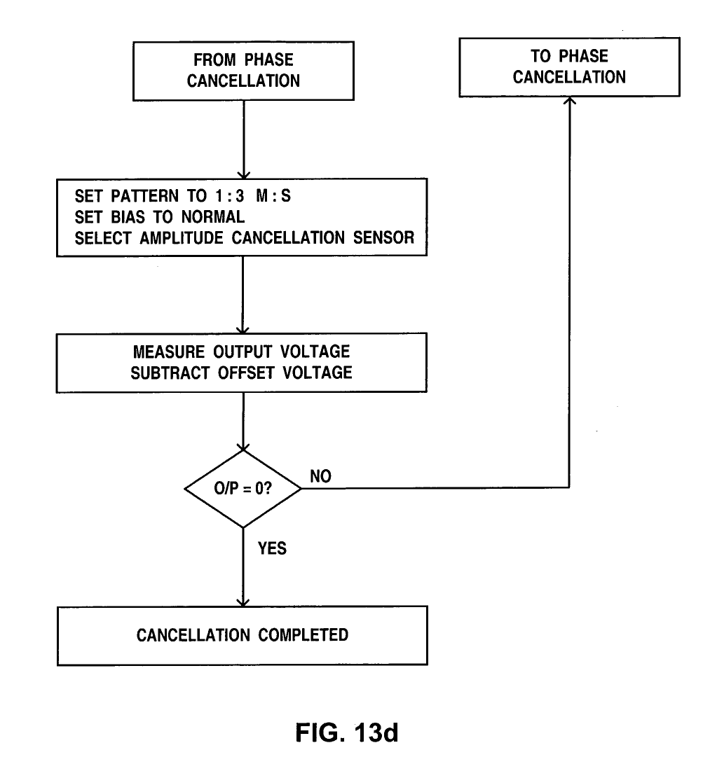

FIGS. 13a, 13b, 13c and 13d shows a typical flow diagram for the cancellation algorithm. There are four main steps in the cancellation procedure. First, calibration of offsets in the amplitude cancellation sensor is performed. Offset calibration is followed by amplitude cancellation. Phase cancellation follows amplitude cancellation and finally an amplitude cancellation check is performed to ensure that the phase cancellation has not disturbed the amplitude cancellation. Dependent on whether the cancellation signal buffers 14 and 15 allow independent control of amplitude and phase it may be necessary to iterate around the amplitude and phase cancellation loops and this possibility is shown in the flow diagram.

Although the preferred embodiment only has been described in detail, it should be understood that various changes, substitutions and alterations can be made therein without departing from the spirit and scope of the invention as defined by the appended claims.

We claim:

1. An integrated circuit for point to point simultaneous bidirectional differential high speed signalling to another integrated circuit connected thereto, the integrated circuit comprising:
a transmitter for transmitting a first signal to another integrated circuit; the transmitter having an output buffer;
a receiver for receiving a second signal from the other integrated circuit, the receiver having a receiver buffer and co-located on the same integrated circuit; and
a differential buffer coupled between the input of the transmitter buffer and the output of the receiver buffer;
wherein the first signal at the output of the transmitter buffer is coupled into the input of the receiver buffer; and a third signal at the input of the transmitter buffer is passed through the differential buffer and coupled onto the output of the receiver buffer;
wherein the differential buffer adjusts the third signal in phase and amplitude to cancel the first signal at the output of the receiver buffer, whereby the quality of receiving the second signal is enhanced by canceling echoing of the first signal.

2. The integrated circuit according to claim 1, wherein the differential buffer is implemented as a chain of buffer stages.

3. The integrated circuit according to claim 2, wherein the gain and phase of the buffer chain is adjusted for the maximum signal cancellation.

4. The integrated circuit according to claim 2, wherein the phase of the third signal is shifted by opposite to the phase of the first signal.

5. The integrated circuit according to claim 2 wherein the gain of the differential buffer is varied by means of a finite state machine using a training pattern following power up or on request.

6. The integrated circuit according to claim 1 wherein the third signal is varied in phase.

7. The integrated circuit according to claim 1 wherein the differential buffer has a variable current source for the purpose of setting the amplitude or phase of the third signal.

8. The integrated circuit according to claim 5 wherein the differential buffer has a programmable or variable load which is set by a finite state machine following a training pattern initiated after power up or on request.

9. The integrated circuit according to claim 1 wherein the load in the differential buffer providing the third signal is implemented as N-type FET transistors to minimise the parasitic capacitance.

10. The integrated circuit according to claim 5 wherein the finite state machine employs a peak detector and means of reading a parameter related to the peak detector to set a value through digital to analogue converters which controls the currents sources in the differential stages in the chain of buffers providing the third signal between the transmitter and receiver.

11. The integrated circuit according to claim 10 wherein the peak detector comprises an amplitude cancellation sensor.

12. The integrated circuit according to claim 10 wherein the peak detector comprises a phase cancellation sensor.

13. The integrated circuit according to claim 5 wherein the state machine controls the amplitude and/or phase adjustment on power up or on request, sequentially, first the master and then the slave.

14. The integrated circuit according to claim 1 wherein either the differential buffer or the output buffer of the transmitter is adapted to be switched off with the effect that the first signal is not canceled but is passed to the receiver for testing purposes.

15. An apparatus for point to point simultaneous bidirectional differential high speed signalling between integrated circuits, comprising an integrated circuit connected to another integrated circuit, each integrated circuit comprising:
a transmitter for transmitting a first signal to another integrated circuit; the transmitter having an output buffer;
a receiver for receiving a second signal from the other integrated circuit, the receiver having a receiver buffer and co-located on the same integrated circuit;
a differential buffer coupled between the input of the transmitter buffer and the output of the receiver buffer; and
a state machine for controlling the differential buffer in gain and phase;
wherein the first signal at the output of the transmitter buffer is coupled into the input of the receiver buffer; and
a third signal at the input of the transmitter buffer is passed through the differential buffer and coupled onto the output of the receiver buffer;
wherein the differential buffer adjusts the third signal in phase and amplitude to cancel the first signal at the output of the receiver buffer, whereby the quality of receiving the second signal is enhanced by canceling echoing of the first signal.

16. The apparatus according to claim 15 wherein the differential buffer has a programmable or variable load which is set by the finite state machine following a training pattern initiated after power up or on request.

17. The apparatus according to claim 15 wherein the finite state machine employs a peak detector and means of reading a parameter related to the peak detector to set a value through digital to analogue converters which controls the currents sources in the differential stages in the chain of buffers providing the third signal between the transmitter and the receiver.

18. The apparatus according to claim 17 wherein the peak detector comprises an amplitude cancellation sensor.

19. The apparatus according to claim 18 wherein the amplitude cancellation sensor comprises an integrator plus a sample and hold device.

20. The apparatus according to claim 19 wherein the integrator includes a reset phase, an integration phase and a transfer phase.

21. The apparatus according to claim 17 wherein the peak detector comprises a phase cancellation sensor.

22. The apparatus according to claim 21 wherein the timing of the phases for the phase cancellation sensor is controlled by the finite state machine.

23. The apparatus according to claim 21 wherein the phase cancellation sensor comprises a full wave rectifier plus integrator plus a sample and hold.

24. The apparatus according to claim 23 wherein the integrator includes a reset phase, an integration phase and a transfer phase.

25. The apparatus according to claim 17 wherein the peak detector comprises both an amplitude and a phase cancellation sensors.

26. The apparatus according to claim 25 where the selection of the amplitude or phase cancellation sensor is controlled by the finite state machine.

27. The apparatus according to claim 25 wherein the timing of the phases for the phase cancellation sensor is controlled by the finite state machine.

28. The apparatus according to claim 15 wherein patterns are injected into the transmitter for the purpose of measuring the offset in the amplitude cancellation sensor.

29. The apparatus according to claim 15 wherein multiple patterns are selectable by the finite state machine for the purposes of offset calibration, amplitude cancellation and phase cancellation.

30. A method for echo cancellation in simultaneous bidirectional differential high speed signalling, where the signalling is from one integrated circuit connected to another integrated circuit, each circuit comprising a transmitter having an output buffer and a receiver having a receiver buffer; the method comprising:
transmitting a first signal from the output buffer of the transmitter arranged on one integrated circuit, to another circuit, the first signal being coupled also into the input buffer of the receiver co-located with the transmitter on the same integrated circuit;
receiving a second signal from the other integrated circuit;
transmitting a third signal from the input of the transmitter buffer through a differential buffer where the third signal is adjusted in phase and amplitude; and
coupling the adjusted signal onto the output of the receiving buffer to cancel the first signal, whereby the quality of receiving the third signal is enhanced by canceling echoing of the first signal.

31. A method according to claim 30, wherein the phase of the third signal applied to the output of the receiving buffer is opposite to the phase of the first signal.

32. A method according to claim 30 wherein the gain of the differential buffer is varied by means of a finite state machine using a training pattern.

33. A method according to claim 30 wherein the phase and/or amplitude of the third signal is adjusted by applying a training pattern and minimising peak to peak noise by varying the codes in DACs, measuring noise using a peak detector and ADC to determine which code corresponds to the minimum noise using state machine and applying the determined code to the DACs at the end of adjustment process.

34. A method according to claim 30 wherein one of the circuits is a master die and another is a slave die, while the determining is repeated twice, first to configure the master die, and second to configure the slave die.
